(19) United States
(12) Patent Application Publication
(10) Pub. No.: US 2011/0285951 A1
(43) Pub. Date: Nov. 24, 2011

(54) CNT COMPOSITION, CNT LAYER STRUCTURE, LIQUID CRYSTAL DISPLAY DEVICE, METHOD OF PREPARING CNT LAYER STRUCTURE, AND METHOD OF PREPARING LIQUID CRYSTAL DISPLAY DEVICE

(75) Inventors: Seon-mi YOON, Yongin-si (KR); Honglong NING, Suwon-si (KR); Chang-oh JEONG, Suwon-si (KR); Jae-young CHOI, Suwon-si (KR); Won-mook CHOI, Hwaseong-si (KR); Hyeon-jin SHIN, Suwon-si (KR)

(73) Assignee: SAMSUNG ELECTRONICS CO., LTD, Suwon-si (KR)

(21) Appl. No.: 12/897,198

(22) Filed: Oct. 4, 2010

(30) Foreign Application Priority Data
May 18, 2010 (KR) 10-2010-0046591

(51) Int. Cl. G02F 1/1343; B05D 5/06; H01B 1/04; B82Y 20/00

(52) U.S. Cl. 349/139; 252/502; 428/1.51; 427/66; 977/742; 977/750; 977/752

(57) ABSTRACT

A carbon nanotube (“CNT”) composition includes CNTs, a dispersing agent containing a reactive functional group, and at least one kind of dispersion medium. A CNT layer structure includes a substrate and a CNT layer disposed on the substrate, the CNT layer including the CNT composition including the CNTs arranged in a network-shape, and an organic material adsorbed to the CNTs and chemically bonded to the substrate. A liquid crystal display device includes the CNT layer structure. A method of manufacturing the CNT layer structure uses the CNT composition. A method of manufacturing the liquid crystal display device includes forming a pixel electrode on a passivation layer, by using the method of manufacturing the CNT layer structure.

### CROSS-REFERENCE TO RELATED APPLICATIONS

This application claims priority to Korean Patent Application No. 10-2010-0046591, filed on May 18, 2010, and all the benefits accruing therefrom under 35 U.S.C. §119, the disclosure of which is incorporated herein in its entirety by reference.

### BACKGROUND

1. Field

Provided are carbon nanotube (“CNT”) compositions, CNT layer structures, liquid crystal display devices, methods of preparing the CNT layer structures, and methods of preparing the liquid crystal display devices, and more particularly, to CNT compositions including a dispersing agent having a reactive functional group, CNT layer structures prepared using the CNT compositions, liquid crystal display devices including the CNT layer structures, methods of preparing the CNT layer structures using the CNT compositions, and methods of preparing the liquid crystal display devices, including forming a pixel electrode on a passivation layer by the methods of preparing the CNT layer structures.

2. Description of the Related Art

A variety of devices require transparent electrodes, and the most frequently used transparent electrode is an indium tin oxide (“ITO”) electrode. However, the price of ITO is increasing due to the increasing consumption of indium, and when the ITO electrode is bent, cracks occur therein, and thus, an electric resistance of the ITO electrode is increased. Accordingly, there is a need to develop an alternative electrode material to the ITO used as a transparent electrode material of a flexible device.

One of such alternative electrode materials is a CNT. A CNT transparent electrode may be used in, in addition to conventional liquid crystal displays (“LCD”), organic light emitting diode (“OLED”) displays, paper-like displays, solar cells and the like. The CNT has a strong mechanical property, and thus, the CNT is suitable for an electrode material used in a flexible device. However, in order to use the CNT in a device, for example, in order to use the CNT as a material for forming a pixel electrode formed on a thin film transistor (“TFT”) substrate of a LCD, it is important to secure patternability, and formation of a layer in an uneven substrate of the LCD. In addition, the structure of a substrate also needs to be considered. That is, in order to use the CNT as a material for forming a pixel electrode of a LCD, patternability and uniformity of a CNT layer formed on an uneven surface by a solution process need to be secured.

For example, a CNT electrode is formed on a passivation layer, which has a hole filled with a CNT electrode material, so as to allow a TFT electrode to contact the CNT electrode. The hole of the passivation layer is formed by dry etching. In this regard, since the shape of the passivation layer is changed according to conditions for the dry etching, the connectivity of a CNT layer having a network structure in the vicinity of the hole may be degraded correspondingly. That is, since the CNT electrode is manufactured by a solution process, when a dispersion medium contained in a CNT composition is dried, the CNT layer of a network structure may be partially disconnected in the vicinity of the hole along the shape of the hole formed in the passivation layer.

In regard to a conventional CNT transparent electrode, in order to obtain high electrical conductivity, CNTs or acid-treated CNTs are dispersed in a dispersion medium to form a layer formed of only CNTs, and alternatively, CNTs are dispersed in water by using a low molecular weight organic material as a dispersing agent to form a layer and then the used dispersing agent is removed by washing. However, in these cases, the formed layers have poor adhesion characteristics with respect to a substrate. In order to improve the adhesion characteristics, the CNT transparent electrode may be over-coated with a polymer, or the CNT transparent electrode may be manufactured using a polymer-containing CNT composition. However, in these cases, electrical conductivity of the CNT transparent electrode is reduced.

In general, CNT compositions for forming a CNT layer are divided into the following three categories (1) a first CNT composition prepared by dispersing CNTs or acid-treated CNTs in a dispersion medium without a dispersing agent, 2) a second CNT composition prepared by dispersing CNTs or acid-treated CNTs in an aqueous solution using a surfactant such as sodium dodecylbenzene sulfonate (NaDDBS) and Triton X-100® (t-Oct-C₆H₄-(OCH₂CH₂)ₓOH, x=9-10), and (3) a third CNT composition prepared by dispersing CNTs or acid-treated CNTs together with a polymer as a binder in a dispersion medium.

The electric resistance of the first CNT composition is lower than the electric resistance of the second CNT composition, and the electric resistance of the second CNT composition is lower than the electric resistance of the third CNT composition. The adhesion of the first CNT composition is poorer than the adhesion of the second CNT composition, and the adhesion of the second CNT composition is poorer than the adhesion of the third CNT composition. In addition, CNTs are poorly adhesive with respect to a non-carbonaceous material such as glass. Accordingly, when a CNT layer is formed on an inorganic material substrate formed of a non-carbonaceous material, or used in a device requiring a patterning process, such as a pixel electrode of a LCD, the electric resistance of the CNT layer itself and adhesion characteristics of the CNT layer with respect to a substrate need to be improved.

### SUMMARY

Provided are carbon nanotube (“CNT”) compositions including a dispersing agent including a reactive functional group.

Provided are methods and apparatuses for CNT layer structures prepared using the CNT composition.

Provided are liquid crystal display devices including the CNT layer structures.

Provided are methods of preparing the CNT layer structures by using the CNT compositions.

Provided are methods of preparing the liquid crystal display devices, including forming a pixel electrode on a passivation layer by using the methods of preparing the CNT layer structures.

Additional aspects will be set forth in part in the description which follows and, in part, will be apparent from the description, or may be learned by practice of the illustrated embodiments.

Provided is a CNT composition including CNTs, a dispersing agent including a reactive functional group, and a dispersion medium.

The CNTs includes a CNT selected from the group consisting of a single-walled CNT, a double-walled CNT, a thin multi-walled CNT, a multi-walled CNT and a combination thereof.

The reactive functional group has a polarity, and includes an atom species selected from the group consisting of carbon (C), hydrogen (H), oxygen (O), nitrogen (N), sulfur (S), phosphorous (P) and a combination thereof.

The reactive functional group includes a functional group selected from the group consisting of a carboxyl group, an acetate group, a nitrate group, a hydroxy group, a phosphate group, an imine group, an amine group, an amide group, an epoxy group and a combination thereof.

The dispersing agent has a weight average molecular weight of about 20,000 or less.

The dispersing agent includes a polymer selected from the group consisting of polyacrylic acid, poly(ethylene imine), poly(allylamine), poly(4-styrenesulfonic acid), polymethacrylic acid, polyphosphonates, polyacrylamides, polyvinyl alcohols, polyvinyl acetates, cellulose nitrates, glycogens and a combination thereof.

The dispersion medium includes a first liquid and a second liquid. The first liquid is hydrophilic and the second liquid is miscible with the first liquid. The dispersing agent has a higher dissolvibility in the second liquid than the first liquid.

The first liquid is water and the second liquid is a hydroxy group-containing material.

The second liquid includes alcohols.

When an external energy is applied to the dispersing agent, a chemical reaction occurs between two or more functional groups of the reactive functional group, between the reactive functional group and another reactive functional group, or between the reactive functional group and external oxygen.

The chemical reaction is a condensation reaction by hydrogen bonding or hydrolysis.

Provided is a CNT layer structure including a substrate, and a CNT layer disposed on the substrate. The CNT layer includes CNTs arranged in a network-shape, and an organic material adsorbed to the CNTs and chemically bonded to the substrate.

The chemical bonding includes a hydrogen bonding.

The CNT layer has a patterned structure.

The substrate includes a hole, and a portion of the CNT layer is disposed in the hole.

The hole includes a width which is tapered in such a way that the width of the hole decreases in a direction toward the substrate.

Provided is a liquid crystal display device includes the CNT layer structure described above.

The substrate is a passivation layer, and the CNT layer is a pixel electrode.

Provided is a method of manufacturing a CNT layer structure, the method including coating the CNT composition described above on a substrate, and providing an external energy to the CNT composition coated on the substrate, to form a CNT layer.

The external energy is provided by heat-treating.

The heat treatment is performed at a temperature of about 80° C. to about 250° C.

The method may further include pattering the CNT layer.

Provided is a method of manufacturing a liquid crystal display device, the method including forming a pixel electrode on a passivation layer by using the method of manufacturing a CNT layer structure described above.

Provided is a display device including a first substrate including a first electrode, a second substrate facing the first substrate and including a second electrode in pixel regions, and an electro-optical active layer between the first and second substrates. The second electrode includes a CNT layer structure. The CNT layer structure includes a passivation layer on the second substrate and a CNT layer directly on the passivation layer. The CNT layer includes carbon nanotubes including an organic material adsorbed to the carbon nanotubes, the organic material being chemically bonded to the passivation layer.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view of an embodiment of a liquid crystal display device, according to the present invention;

FIG. 2 is an enlarged cross-sectional view of portion A of FIG. 1;

FIG. 3 shows photographs of embodiments of surfaces of carbon nanotube (“CNT”) layer structures respectively formed using a CNT composition according to the present invention and a conventional CNT composition on a glass substrate, taken before and after washing;

FIG. 4 shows optical images of embodiments of surfaces of CNT layer structures respectively formed using CNT compositions according to the present invention on a silicon nitride (SiN) substrate, taken before and after washing;

FIG. 5 are graphs showing C1s and O1s X-ray photoelectron spectroscopy (XPS) spectra versus binding energy in electron volts (eV), of embodiments of CNT layer structures respectively formed using a CNT composition according to the present invention and a conventional CNT composition on a silicon nitride (SiN) substrate, taken before and after a heat treatment, and after the heat treatment and then washing; and

FIG. 6 shows embodiments of images displayed by a liquid crystal display device including a pixel electrode formed using CNT compositions according to the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. In the drawings, the size and relative sizes of layers and regions may be exaggerated for clarity.

It will be understood that when an element or layer is referred to as being “on” or “connected to” another element or layer, the element or layer can be directly on or connected to another element or layer, or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “upper,” “lower” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

A carbon nanotube (“CNT”) composition includes a CNT, a dispersing agent containing a reactive functional group, and a dispersion medium.

A CNT is a tube-shaped substance that contains a plurality of hexagonal structures, each of which consists of six carbon atoms and which are connected to form a tube shape. A diameter of the tube is as small as a few to tens of nanometers (nm). The CNT can be categorized into a single-walled CNT, a double-walled CNT, a thin multi-walled CNT, and a multi-walled CNT, according to the number of tube layers forming the CNT, and the purposes of the respective CNT are not limited. The CNT may have a thickness of 30 nm or less, for example, 10 nm or less.

The CNT may include a CNT selected from the group consisting of a single-walled CNT, a double-walled CNT, a thin multi-walled CNT, a multi-walled CNT and a combination thereof.

The reactive functional group has a polarity, and may include at least one atom species selected from the group consisting of carbon (C), hydrogen (H), oxygen (O), nitrogen (N), sulfur (S), phosphorous (P) and a combination thereof. Accordingly, two or more reactive functional groups repel each other so that the dispersing agent is dispersed in the dispersion medium. The reactive functional group may include a functional group selected from the group consisting of a carboxyl group, an acetate group, a nitrate group, a hydroxy group, a phosphate group, an imine group, an amine group, an amide group, an epoxy group and a combination thereof.

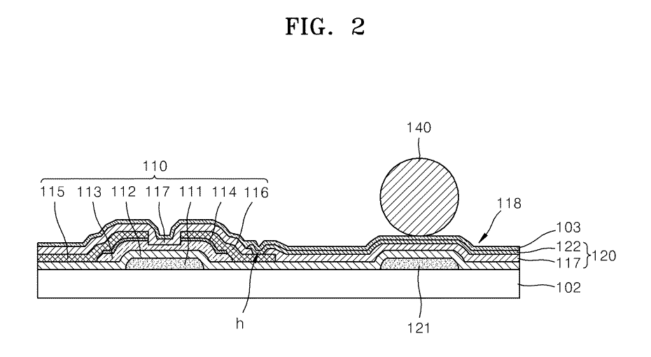

The dispersing agent may have a weight average molecular weight of about 20,000 or less. If the weight average molecular weight of the dispersing agent is within the range described above, the residual organic material that is not adsorbed to the CNT after the formation of a CNT layer structure (see 120 of FIG. 2), which will be described later, is easily removed by washing. With the washing, excess organic materials contained in a CNT layer are removed and a sheet resistance of the CNT layer is maintained at a low level.

The dispersing agent may include a polymer selected from the group consisting of polyacrylic acid, poly(ethylene imine), poly(allylamine), poly(4-styrenesulfonic acid), polymethacrylic acid, polyphosphonates, polyacrylamides, polyvinyl alcohols, polyvinyl acetates, cellulose nitrates, glycogens and a combination thereof.

The dispersion medium may include a first liquid and a second liquid. The first liquid is hydrophilic and the second liquid may be miscible with the first liquid, and the dispersing agent may be more dissolved in the second liquid than in the first liquid.

Accordingly, the dispersion medium may be a mixed solution containing the first liquid and the second liquid, and may dissolve at least a part of the dispersing agent and cured product thereof. Thus, the dispersion medium enables the CNT composition to form a uniform layer in which segregation of the residual organic material does not occur, in a CNT layer structure forming process, which will be described later. Thus, a uniform CNT layer after washing may be obtained.

The segregation of the residual organic material is prevented by controlling solubility of the dispersing agent. The solubility constant of the dispersing agent may be slightly different from the solubility constant of the first liquid. So, in regard to the CNT composition including a very small amount of the dispersing agent, although the dispersing agent is well dissolved in the first liquid, when the dispersion medium is removed in a CNT composition droplet formation process or a CNT composition drying process among a CNT layer formation process, the solubility of the dispersing agent with respect to the first liquid is considerably decreased. Accordingly, if the CNT composition further includes the second liquid that has a solubility constant similar to that of the dispersing agent and is well miscible with the first liquid, the segregation of the residual organic material may be decreased.

If the segregation of the residual organic material occurs, a surface roughness of the CNT layer is increased, and since the segregated residual organic material is highly adhesive to a photosensitive layer, when the photosensitive layer (e.g., a photoresist) is removed, the CNT layer may be damaged or the surface of the CNT layer may be uneven. In this regard, the term ‘the residual organic material’ refers to a material that is not adsorbed to CNTs and functions as a dispersion stabilizer in the CNT composition, and is removed by washing after a patterning process.

In one embodiment, for example, the first liquid may be water and the second liquid may be a hydroxy group-containing material such as alcohols.

When an external energy is applied to the dispersing agent, two or more functional groups of the reactive functional groups may chemically react with each other. In this regard, the reactive functional group may also react with another reactive functional group present in the CNT composition or an external reactive functional group. The reactive functional group may also chemically react with oxygen present in a substrate, which will be described later. Due to the chemical reaction, the dispersing agent may be cured. The cured product of the dispersing agent binds CNTs and then the adhesion among CNT particles is increased, and thus, the network-shaped CNT structure may be stably retained. As described above, the dispersing agent may chemically react with oxygen present in a substrate. Accordingly, the adhesion between the CNT layer with the substrate is increased and thus, separation of the CNT layer from the substrate in a process of preparing the CNT layer structure, which will be described later, is reduced or effectively prevented. In embodiments, each of the chemical reactions may be a condensation reaction by hydrogen bonding or hydrolysis.

Hereinafter, an embodiment of a CNT layer structure according to the present invention will be described in detail.

The CNT layer structure may include a substrate and a CNT layer.

The substrate contacts and supports the CNT layer.

The substrate may include a hole, and a part of the CNT layer may fill the hole. The hole may be tapered in such a way that the width of the hole decreases in a direction toward the substrate (refer to ‘h’ of FIG. 2). The hole extends completely through a thickness of the substrate, such that the substrate solely defines the hole ‘h’. If the hole is tapered in the aforesaid way, the coverage and connectivity of the CNT layer, which fills the hole, may be improved. Herein, the term ‘connectivity’ refers to a degree of continuity of the network-shaped CNT structure.

The CNT layer may be disposed on the substrate, and may include CNTs disposed in a network-shape, and an organic material that is adsorbed to the CNTs and chemically bonded to the substrate. The chemical bond may be, for example, a hydrogen bond between the reactive functional group of the dispersing agent and oxygen of the substrate. In this regard, the term ‘organic material’ may be a cured product of the dispersing agent, and/or a reaction product of the dispersing agent and the substrate.

In regard to a CNT layer structure having the structure as described above, the organic material is adsorbed to the CNT particles, and is then chemically bonded to the substrate. Accordingly, since the adhesion among the CNT particles is increased by intervention of the organic material, separation of some of the CNTs from the CNT layer structure may be reduced or effectively prevented. In addition, due to the increased adhesion between CNTs and the substrate by intervention of the organic material, separation of some of the CNTs from the substrate may also be reduced or effectively prevented.

The CNT layer structure may be prepared by coating the CNT composition on the substrate, and forming a CNT layer by providing an external energy to the CNT composition coated on the substrate. In this regard, the term ‘external energy’ is an energy that induces the reactive functional groups of the dispersing agent contained in the CNT composition to undergo a self-reaction and/or to chemically react with other materials. The external energy may be, for example, heat or ultra violet (“UV”) rays.

The external energy may be provided by, for example, heat-treatment. That is, the substrate and the CNT composition coated on the substrate are heat treated so that the dispersion medium is removed, the dispersing agent is cured, and the dispersing agent is chemically bonded to the substrate, thereby forming a CNT layer. The heat treatment may be performed at a temperature of about 80° C. to about 250° C. If the heat treatment temperature is within the range described above, the dispersing agent may be strongly chemically bonded to the substrate and also, decomposition of CNTs or the organic material may be reduced or effectively prevented.

The CNT layer may be patterned when the CNT composition is coated on the substrate. Alternatively, the CNT layer may be patterned in such a way that the CNT composition is coated on a surface of the substrate, and, for example, heat-treated to form a CNT layer, a photosensitive layer is formed on the CNT layer and is exposed to light via an optical mask, an un-exposed portion of the photosensitive layer is removed, the exposed CNT layer is dry etched, and the remaining photosensitive layer is removed by washing.

The former patterning of the CNT layer may be performed by coating the CNT composition on the substrate by, for example, ink-jet printing, or by coating the CNT composition on a mask-covered substrate by using various coating methods. The latter patterning of the CNT layer may be performed by dry etching a CNT layer formed by coating the CNT composition on the substrate by, for example, spray coating, bar coating, or spin coating and then additionally heat treating the coated layer.

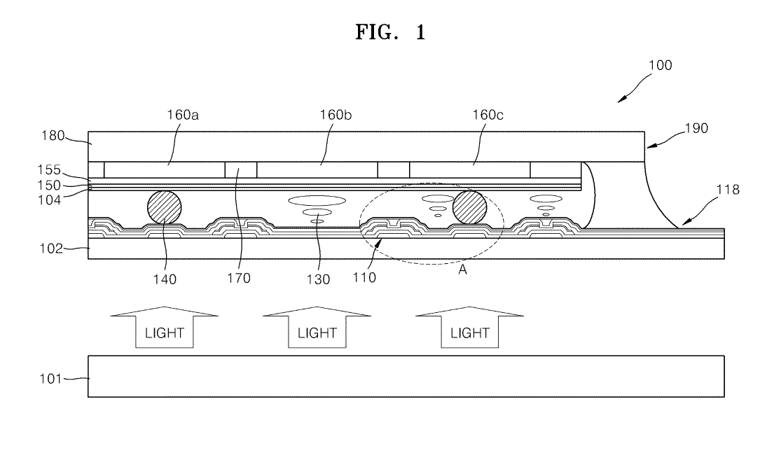

Hereinafter, an embodiment of a liquid crystal display device according to the present invention will be described in detail with reference to FIGS. 1 and 2.

FIG. 1 is a cross-sectional view of an embodiment of a liquid crystal display device 100 according to the present invention, and FIG. 2 is an enlarged cross-sectional view of portion A of FIG. 1.

Referring to FIGS. 1 and 2, the liquid crystal display device 100 according to the present embodiment includes a backlight unit 101, a thin film transistor array substrate 118, a plurality of a liquid crystal 130 in a liquid crystal layer, a spacer 140, and a color filter array substrate 190. The liquid crystal display includes the liquid crystal layer as an electro-optical active layer.

The thin film transistor array substrate 118 is exposed directly to light emitted by the backlight unit 101. The thin film transistor array substrate 118 may include a first substrate 102, a thin film transistor 110 on the first substrate 102, a pixel electrode 122 on the first substrate 102 (see FIG. 2), a storage capacitor electrode (“Cs electrode”). 121 on the first substrate 102 (see FIG. 2), and an alignment layer 103 on the first substrate 102 (see FIG. 2).

The thin film transistor 110 is a switching device for transferring an externally input electrical signal, that is, an image signal to the liquid crystals 130, or blocking the electrical signal from the liquid crystals 130. In one embodiment, for example, the thin film transistor 110 may have the same structure as illustrated in FIG. 2, or may have a structure similar to that illustrated in FIG. 2.

Referring to FIG. 2, the thin film transistor 110 may include a gate electrode 111, a gate insulating layer 112, a hydrogenated amorphous silicon (“a-Si:H”) layer 113 that is an activation layer, an n+ doped hydrogenated amorphous silicon (“n+ a-Si:H”) film 114 that is an ohmic contact layer, a source electrode 115, a drain electrode 116, and a passivation layer 117 formed of, for example, SiN. In an alternative embodiment, a thin film transistor having a structure different from the thin film transistor 110 may also be used in the liquid crystal display device 100. The passivation layer 117 may be on an entire of the first substrate 102, except for where the hole ‘h’ is disposed. The passivation layer 117 may be a single unitary indivisible element on the first substrate 102.

In FIG. 2, the passivation layer 117 and the pixel electrode 122 disposed thereon may collectively form the CNT layer structure 120. That is, the pixel electrode 122 may be the CNT layer of the CNT layer structure 120, according to the present invention.

The Cs electrode 121 may be disposed on the substrate 102 and separate from the thin film transistor 110, as illustrated in FIG. 2.

The alignment layer 103 is disposed as an uppermost layer of the thin film transistor array substrate 118, and allows the liquid crystals 130 to be aligned in a given direction together with an alignment layer 104 (see FIG. 1) as an innermost layer of the color filter array substrate 190.

The liquid crystals 130 block or transmit light emitted by the backlight unit 101 to control red, green, and blue color filters 160a, 160b, and 160c of the color filter array substrate 190.

The spacer 140 maintains an interval between the thin film transistor array substrate 118 and the color filter array substrate 190.

Referring to FIG. 1, the color filter array substrate 190 includes a second substrate 180, a plurality of a black matrix 170 disposed on the substrate 180 along boundaries of pixel regions, red, green, and blue color filters 160a, 160b, and 160c sequentially disposed between the black matrixes 170, an overcoat layer 155 covering and overlapping the black matrixes 170 and the red, green, and blue color filters 160a, 160b, and 160c, a common electrode 150 disposed on the overcoat layer 155, and the alignment layer 104 disposed on the common electrode 150. A pixel region may be defined as an independent area unit configured to independently control the liquid crystal molecules 130.

The common electrode 150 may face the pixel electrode 122, and may include, for example, indium tin oxide (“ITO”), CNT, or graphene.

The liquid crystal display device 100 may have a structure similar to a known thin film transistor liquid crystal display (“TFT-LCD”), except for inclusion of the CNT layer structure 120 according to the present invention. Accordingly, other members except the CNT layer structure 120 of the liquid crystal display device 100 will not be described in detail.

In addition, an embodiment of a method of manufacturing a liquid crystal display device according to the present invention includes forming a pixel electrode on a passivation layer using the methods of preparing the CNT layer structures.

The present invention will be described in further detail with reference to the following examples. These examples are for illustrative purposes only and are not intended to limit the scope of the present invention

### Examples 1 to 3 and Comparative Example 1

### Preparation of CNT Compositions

15 milligrams (mg) of single-walled CNT (Hanwha Nanotech, product number ASP-100F) and 15 mg of a dispersing agent were mixed, and then 30 milliliters (ml) of a dispersion medium was added thereto. The amounts of the dispersing agent and the dispersion medium are shown in Table 1. Then, the resultant was dispersed by using an ultrasonicator (Jeio Tech, Model ULH-7005) at 210 watts (W) for 9 minutes, the dispersed product was centrifuged at a rotation speed of 10000 revolutions per minute (rpm) for 10 minutes by using a centrifuger (Thermo Scientific, Heraeus Multifuge Model X3R), and the precipitate was collected to obtain an appropriately dispersed CNT composition.

TABLE 1

| | Types of Dispersing Agent | Types of Dispersion Medium |
|---|---|---|
| Example 1 | Polyacrylic acid (Molecular | Water |
| | Weight: about 5000) | |
| Example 2 | Polyacrylic acid (Molecular | 20 vol % ethanol aqueous |
| | Weight: about 5000) | solution |
| Example 3 | Polyacrylic acid (Molecular | 20 vol % isopropyl alcohol |
| | Weight: about 5000) | aqueous solution |
| Comparative | Sodium dodecylbenzene | water |
| Example 1 | sulfonate (NaDDBS) | |

### Evaluation Example 1

### Quality Evaluation (1) of CNT Layer Structures

Each of the CNT compositions prepared according to Example 1 and Comparative Example 1 was coated on a glass substrate at a temperature of 120° C. by using a spray coater (NCS Co., Ltd, Model ncs-400) to form a CNT layer. Then, the CNT layer formed on the glass substrate was dipped in water for about 10 minutes and dried.

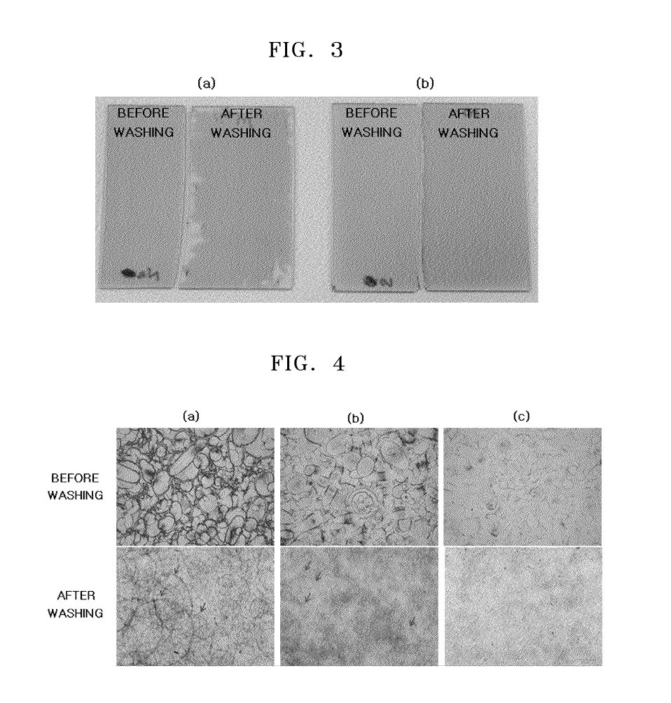

In this case, surfaces of the CNT layer structures before and after washing with water were photographed by using a digital camera (Olympus, Model C5050). The taken pictures are shown in FIG. 3. FIG. 3 (a) shows a picture of the surface of the CNT layer structure prepared using the CNT composition prepared according to Comparative Example 1, and FIG. 3 (b) shows a picture of the surface of the CNT layer structure prepared using the CNT composition prepared according to Example 1.

Referring to FIG. 3 (a), in the case of the CNT composition prepared according to Comparative Example 1, when the CNT layer structure was washed, some CNTs were separated from the glass substrate and the CNT layer was damaged (e.g., the light colored areas in the “after washing” picture). In contrast, referring to FIG. 3 (b) in the case of the CNT composition prepared according to Example 1, the CNT layer was not damaged (e.g., a substantially uniform shading in the “after washing” picture). Such results may be derived from improved adhesion among CNTs and between CNTs and the glass substrate when the CNT composition prepared according to Example 1 was used, compared to when the CNT composition prepared according to Comparative Example 1 was used.

From the results, it can be seen that the CNT composition prepared according to Comparative Example 1 is not suitable for manufacturing a pixel electrode of a liquid crystal display device.

### Evaluation Example 2

### Quality Evaluation (2) of CNT Layer Structures

CNT layer structures were prepared in the same manner as in Evaluation Example 1, except that each of the CNT compositions prepared according to Examples 1 through 3 was coated on a SiN substrate having a thickness of 1000 Angstrom (Å).

In this case, surfaces of the CNT layer structures before and after washing with water were photographed by using a laser microscope (Olympus, Model OLS 3000; 408 nm, two dimensional (2D)). The images of surfaces of the CNT layer structures before washing are in a first (top) row of FIG. 4, and the images of surfaces of the CNT layer structures after washing are in a second (bottom) row of FIG. 4. FIG. 4 (a) shows an image of the surface of the CNT layer structure prepared using the CNT composition prepared according to Example 1, FIG. 4 (b) shows an image of the surface of the CNT layer structure prepared using the CNT composition prepared according to Example 2, and FIG. 4(c) shows an image of the surface of the CNT layer structure prepared using the CNT composition prepared according to Example 3.

Referring to FIG. 4, it can be seen that the surface state of a CNT layer varies according to the type of dispersion medium used in a CNT composition. When an alcohol aqueous solution is used, an organic material is less segregated in the CNT layer than when only water is used. In FIGS. 4 (a) and 4 (b), the images in the first row show formation of stains in the CNT layers, which indicates segregation of the organic material. The segregation of the organic material is related to solubility of the organic material in the dispersion medium, and when alcohol is used (FIG. 4(c)) as the dispersion medium, the solubility of the organic material is increased and thus, the stain is less formed.

The images in the second row in FIG. 4 were taken after the CNT layer structures were washed with water to remove the organic material that was not adsorbed to CNTs. In FIGS. 4 (a) and 4 (b), arrows of the images in the second row indicate that the segregation of the organic material before washing, gives effects on inhomogeneity of a CNT network after washing.

### Evaluation Example 3

### Ingredient Analysis of CNT Layer Structure

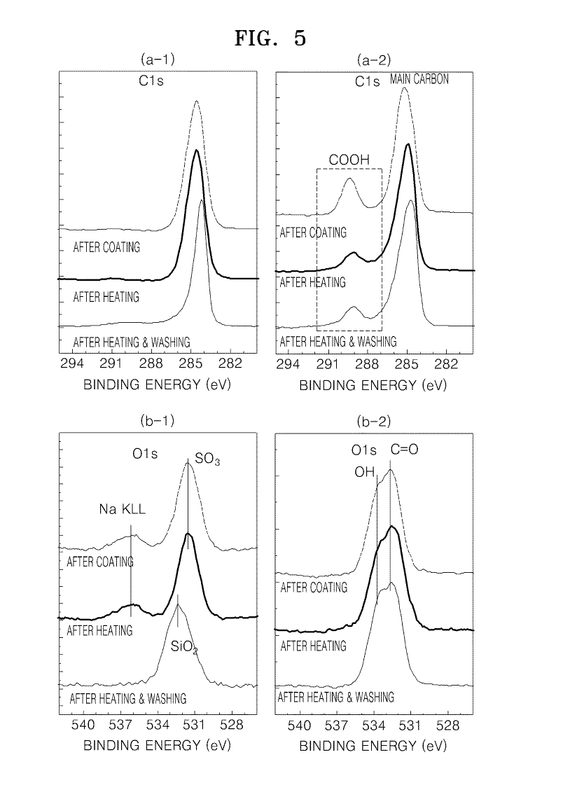

Among the CNT layer structures prepared according to Evaluation Example 2, the CNT layer structures prepared using the CNT compositions prepared according to Comparative Example 1 and Example 3 were analyzed by X-ray photoelectron spectroscopy (XPS), and the obtained C1s and O1s spectra are shown in FIG. 5.

FIGS. 5 (a-1) and (b-1) are results obtained when the CNT composition prepared according to Comparative Example 1 was used, and FIGS. 5 (a-2) and (b-2) are results obtained when the CNT composition prepared according to Example 3 was used.

Referring to FIG. 5 (a-1), in the C1s spectrum, ‘after coating’ and ‘after heating’, a wide peak appears due to sp²/sp³ hybridized bond by the inclusion of the sodium dodecylbenzene sulfonate (NaDDBS), which is a dispersing agent in the CNT composition, and ‘after heating and washing’, a sharp peak appears due to sp² bond in CNTs derived by the removal of NaDDBS.

Referring to FIG. 5 (b-1), in the O1s spectrum, ‘after coating’ or ‘after heating’, there is a peak of SO₃⁻ in NaDDBS, which is a dispersing agent. In the ‘after heating and washing’, there is a peak of SiO₂ contained in the substrate. In FIG. 5 (b-1), ‘Na KLL’ refers to an Auger peak with respect to Na.

Referring to FIG. 5 (a-2), in the C1s spectrum, ‘after coating’, there is a peak of COOH due to the inclusion of a polyacrylic acid, which is a dispersing agent in the CNT composition. In the ‘after heating’ or ‘after heating and washing’, the intensity of the COOH peak is smaller than the intensity of the main carbon peak, and a peak shift toward a low bonding energy occurs.

Referring to FIG. 5 (b-2), in the O1s spectrum, even ‘after heating and washing’, a peak shape of an oxygen-containing group included in the dispersing agent is similar to that of ‘after coating’ and ‘after heating’. Unlike FIG. 5 (a-2), the oxygen-containing peak is high. In FIG. 5 (b-2), when the processing progresses from ‘after coating’ to ‘after heating and washing’, the oxygen-containing peak is reduced and a ratio of OH/CO is reduced. From the above results, it can be assumed that OH is removed from COOH

From the XPS results, when as in Comparative Example 1, a single molecule surfactant such as NaDDBS is used as a dispersing agent, the single molecule surfactant does not react with other materials and its chemical structure does not change by the heat treatment, and thus it is removed during the washing independently from the heat treatment. When as in Example 3, a polyacrylic acid is used as a dispersing agent, the chemical structure of the polyacrylic acid is changed due to the heat treatment and thus the polyacrylic acid remains in the CNT composition even after the heat treatment. Thus, it can be assumed that there was an increase of adhesion between the CNT layer and the substrate.

### Evaluation Example 4

### Quality Evaluation of Pixel Electrode of Liquid Crystal Display Device prepared using CNT Composition According to an Embodiment of the Present Invention

A liquid crystal display device having a structure similar to that illustrated in FIG. 1 was manufactured. In this regard, the CNT compositions prepared according to Examples 1 through 3 were used as a material for forming a pixel electrode. That is, by using the method of preparing the CNT layer structure described in Evaluation Example 1, the CNT compositions prepared according to Examples 1 through 3 were coated on a passivation layer formed of SiN, and a patterning process was additionally performed thereon to form a pixel electrode. Then, the same preparation method as a method of preparing a liquid crystal display device (Samsung, Model LN46C750) was used, using the same materials as in the preparation method for Model LN46C750, except that the CNT pixel electrode was formed instead of an ITO pixel electrode.

The pattering process for forming a pixel electrode was performed as follows. That is, each of the CNT compositions was coated on the passivation layer formed of SiN, and then the coated CNT composition was additionally annealed at a temperature of 180° C. for 30 minutes to form a CNT layer. Then, photoresist (AZ Electronic Materials, AZ-EM®) was coated on the CNT layer, that is, a pixel electrode, by using a slot die method, the photoresist layer was exposed to light through an optical mask (self-manufactured). An un-exposed portion of the photoresist layer was removed by washing it with a tetramethylammonium hydroxide (TMAH) aqueous solution, and then, the exposed portion of the CNT layer was etched by using O₂ reactive ion etching (“RIE”) (80 millitorr (mTorr), 800 W, O₂ flow rate: 400 standard cubic centimeters per minute (sccm), and 30 seconds) and the remaining photoresist layer was washed with TMAH, thereby forming a patterned CNT layer structure. The patterned CNT layer structure includes a passivation layer and a patterned pixel electrode disposed thereon.

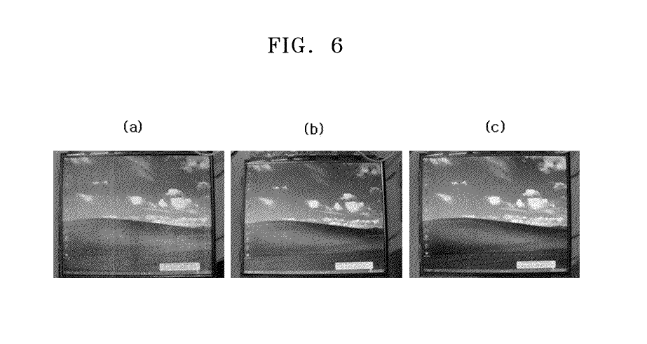

FIG. 6 shows embodiments of images displayed by the manufactured liquid crystal display devices. FIG. 6 (a) shows an image obtained when the CNT composition prepared according to Example 1 was used, FIG. 6 (b) shows an image obtained when the CNT composition prepared according to Example 2 was used, and FIG. 6(c) shows an image obtained when the CNT composition prepared according to Example 3 was used.

Referring to FIG. 6, it can be seen that the image quality of a liquid crystal display device varies according to the type of dispersion medium used in a CNT composition. When an alcohol aqueous solution is used as the dispersion medium, the image quality of the liquid crystal display device (FIG. 6(c)) was higher than when only water was is used as the dispersion medium (FIG. 6 (a)). Such results are attributed to the fact that, as illustrated in FIG. 4, before washing, the organic material that does not adsorb to CNTs is more dissolved in the alcohol aqueous solution (FIG. 4(c)) than in the water (FIG. 4 (a)), and thus, segregation of the organic material is reduced and a uniform layer is formed. In addition, in regard to the segregated organic material, the segregated organic material may have high affinity with respect to photoresist, and thus, when the photoresist is removed, and a portion of the CNT layer in which a great amount of the organic material is present may also be removed.

A CNT composition according to an embodiment of the present invention includes a dispersing agent containing a reactive functional group. Due to the inclusion of the dispersing agent containing a reactive functional group, CNTs have high dispersibility, and when an external energy is supplied to the CNT composition, a chemical reaction may occur between the reactive functional groups, and between the reactive functional group and a substrate.

A CNT layer according to an embodiment of the present invention includes the CNT composition described above. Due to the inclusion of the CNT composition, the CNT layer has a low surface resistance, and high adhesion with respect to a substrate, and a uniform surface.

A liquid crystal display device according to an embodiment of the present invention includes the CNT layer.

A method of manufacturing a CNT layer structure using the CNT composition, according to an embodiment of the present invention, is provided.

A method of manufacturing a liquid crystal display device according to an embodiment of the present invention includes forming a pixel electrode on a passivation layer by using the method of manufacturing the CNT layer structure.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A carbon nanotube composition comprising:
a plurality of a carbon nanotube;
a dispersing agent including a reactive functional group; and
a dispersion medium.

2. The carbon nanotube composition of claim 1, wherein the carbon nanotubes comprises a carbon nanotube selected from the group consisting of a single-walled carbon nanotube, a double-walled carbon nanotube, a thin multi-walled carbon nanotube, and a multi-walled carbon nanotube.

3. The carbon nanotube composition of claim 1, wherein the reactive functional group has a polarity, and comprises an atom species selected from the group consisting of carbon, hydrogen, oxygen, nitrogen, sulfur, phosphorous and a combination thereof.

4. The carbon nanotube composition of claim 3, wherein the reactive functional group comprises a functional group selected from the group consisting of a carboxyl group, an acetate group, a nitrate group, a hydroxy group, a phosphate group, an imine group, an amine group, an amide group, an epoxy group and a combination thereof.

5. The carbon nanotube composition of claim 1, wherein the dispersing agent has a weight average molecular weight of about 20,000 or less.

6. The carbon nanotube composition of claim 1, wherein the dispersing agent comprises a polymer selected from the group consisting of polyacrylic acid, poly(ethylene imine), poly(allylamine), poly(4-styrenesulfonic acid), polymethacrylic acid, polyphosphonates, polyacrylamides, polyvinyl alcohols, polyvinyl acetates, cellulose nitrates, glycogens and a combination thereof.

7. The carbon nanotube composition of claim 1, wherein the dispersion medium comprises a first liquid and a second liquid,
wherein the first liquid is hydrophilic and the second liquid is miscible with the first liquid, and
the dispersing agent has a higher dissolvability in the second liquid than the first liquid.

8. The carbon nanotube composition of claim 1, wherein the first liquid is water, and the second liquid is a hydroxy group-containing material.

9. The carbon nanotube composition of claim 8, wherein the second liquid comprises alcohols.

10. The carbon nanotube composition of claim 1, wherein when an external energy is applied to the dispersing agent, a chemical reaction occurs between two or more functional groups of the reactive functional groups, between the reactive functional group and another reactive functional group, or between the reactive functional group and external oxygen.

11. The carbon nanotube composition of claim 10, wherein the chemical reaction is a condensation reaction by hydrogen bonding or hydrolysis.

12. A carbon nanotube layer structure comprising:
a substrate; and
a carbon nanotube layer disposed on the substrate,
wherein the carbon nanotube layer comprises:
carbon nanotubes arranged in a network-shape; and
an organic material adsorbed to the carbon nanotubes and chemically bonded to the substrate.

13. The carbon nanotube layer structure of claim 12, wherein the chemical bonding comprises a hydrogen bonding.

14. The carbon nanotube layer structure of claim 12, wherein the carbon nanotubes layer are arranged in a patterned structure.

15. The carbon nanotube layer structure of claim 12, wherein the substrate includes a hole, and a portion of the carbon nanotube layer is disposed in the hole.

16. The carbon nanotube layer structure of claim 15, wherein the hole includes a width which is tapered, such that the width of the hole decreases in a direction toward the substrate.

17. A liquid crystal display device comprising:
a carbon nanotube layer structure comprising:
a substrate; and
a carbon nanotube layer disposed on the substrate,
wherein the carbon nanotube layer comprises carbon nanotubes arranged in a network-shape, and an organic material adsorbed to the carbon nanotubes and chemically bonded to the substrate.

18. The liquid crystal display device of claim 17, wherein the substrate is a passivation layer, and the carbon nanotube layer is a pixel electrode.

19. A method of manufacturing a carbon nanotube layer structure, the method comprising:
coating a carbon nanotube composition on a substrate; and
providing an external energy to the carbon nanotube composition coated on the substrate, to form a carbon nanotube layer;
wherein the carbon nanotube composition comprises:
a plurality of a carbon nanotube;
a dispersing agent including a reactive functional group; and
a dispersion medium.

20. The method of claim 19, wherein the external energy is provided by heat-treating.

21. The method of claim 19, wherein the heat treatment is performed at a temperature of about 80° C. to about 250° C.

22. The method of claim 19, further comprising pattering the carbon nanotube layer.

23. A method of manufacturing a liquid crystal display device, the method comprising:
forming a pixel electrode on a passivation layer, the forming a pixel electrode comprising:
coating a carbon nanotube composition on a substrate; and
providing an external energy to the carbon nanotube composition coated on the substrate, to form a carbon nanotube layer;
wherein the carbon nanotube composition comprises:
a plurality of a carbon nanotube;
a dispersing agent including a reactive functional group; and
a dispersion medium.

24. A display device comprising:
a first substrate including a first electrode;
a second substrate facing the first substrate, and including a second electrode in pixel regions; and
an electro-optical active layer between the first and second substrates;
wherein the second electrode includes a carbon nanotube layer structure comprising:
a passivation layer on the second substrate; and
a carbon nanotube layer directly on the passivation layer,
wherein the carbon nanotube layer comprises carbon nanotubes including an organic material adsorbed to the carbon nanotubes, and the organic material is chemically bonded to the passivation layer.
